(19) United States
(12) Patent Application Publication
(10) Pub. No.: US 2022/0101315 A1
(43) Pub. Date: Mar. 31, 2022

(54) SYSTEM AND METHOD FOR IMPLEMENTING DISTRIBUTED MULTIPLE BLOCKCHAIN BASED DIGITAL INDEX TOKEN / UTILITY SMART CONTRACT ON A BLOCKCHAIN AND DISTRIBUTED/ALLOCATION ON MULTIPLE BLOCKCHAIN NETWORKS

(71) Applicant: Sunilkumar Patel, Ridgewood, NJ (US)

(72) Inventor: Sunilkumar Patel, Ridgewood, NJ (US)

(73) Assignee: Moleculus LLC, Ridgewood, NJ (US)

(21) Appl. No.: 17/454,816

(22) Filed: Nov. 14, 2021

(51) Int. Cl. G06Q 20/38; G06Q 20/06

(52) U.S. Cl. CPC G06Q 20/3823; G06Q 20/3825; G06Q 20/065; G06Q 20/3821; G06Q 20/3827

(57) ABSTRACT

A method, architecture, and blockchain-enabled system for implementing blockchain-based index token as a digital asset within the Decentralized Finance industry using a parameterized public smart contract on one blockchain and distributed on multiple using an autonomous algorithmic network implemented the program, updated real-time to Index smart contract and set index ratio/distribution of multiple digital assets/blockchains from oracle blockchain real-time using circulating supply, network activity, weightage, and valuation. The mesh network service program allows interested parties to do a transaction on Index token and allocate Index token as synthetic transaction recorded real-time into respective blockchain network based on collating distribution ratio comprising Index smart contract at the time of transaction submitted, a network program that is embodied as program code integrated with blockchain-based services/application that is stored and synchronized by the respective smart contract logic, the network program defining permissible network defined digital asset types and corresponding functions.

### FIELD OF THE INVENTION

The present invention relates to systems and methods for digital asset index as smart contract derived from distributed multiple tokens' and coins' performance within the decentralized finance industry and related transactions on a blockchain network.

### BACKGROUND OF THE INVENTION

Blockchains are distributed and public ledger which maintains records of all the transactions. A blockchain network is a truly peer-to-peer network and it does not require a trusted central authority or intermediaries to authenticate or to settle the transactions or to control the network infrastructure. Users can interact and transact with the blockchain networks through Externally Owned Wallet (EOWs), which are owned and controlled by the users. Each EOW has a balance (in certain units of a Cryptocurrency associated with the Blockchain network) associated with it. EOWs do not have any associated code. All transactions on a blockchain network are initiated by EOWs. These accounts can send transactions to other EOWs or contract accounts. Another type of account supported by second-generation programmable Blockchain platforms holds the Contract Accounts. A Contract Account is created and owned by an EOW and is controlled by the associated contract code which is stored with the account. The contract code execution is triggered by transactions sent by EOWs or messages sent by other contracts.

Blockchain networks can either be public or private. Public blockchain networks are free and open to all and any user can create an account and participate in the consensus mechanism on a public blockchain and view all the transactions on the network. Blockchain networks can have specific characteristics which need to be implemented by the consumer system. Private blockchain networks are usually controlled and operated by a single organization and the transactions can be viewed only by the users within the organization. Public blockchain networks are usually un-permission or permissionless, as any node can participate in the consensus process. Some public blockchain networks adopt a permission model where the consensus process is controlled by a pre-selected set of nodes. Private blockchain networks usually adopt the permissioned model. While public blockchain networks can be considered fully decentralized, private blockchain networks are partially decentralized.

Crypto exchanges—Crypto exchanges work a lot like brokerage platforms you may be more familiar with. Each offers a portal where you can create different order types to buy, sell and speculate on cryptocurrencies with other users. Crypto exchanges can be centralized, meaning they are managed by one corporate authority, like a brokerage company that facilitates the security of trades or decentralized. Decentralized exchanges generally distribute verification powers to anyone willing to join a network and certify transactions, much like cryptocurrency blockchains themselves. This may help increase accountability and transparency as well as ensure an exchange can keep running if something happens to a company running an exchange.

On each blockchain network, a user can create multiple Externally Owned Wallets (EOWs). Each Externally Owned Wallet (EOW) has a public-private key pair associated with it. The account address is derived from the public key. When a new EOW is created, a key file is created which has the public and private keys associated with the wallet. The private key is encrypted with the password which is provided while creating the wallet. For sending transactions to other wallets, the private key and the wallet password are required.

The “coin” is a digital currency, built INTO Blockchain, the same as the physical currency having its value and used as a source of payment. In technical terms, Coins are cryptocurrencies having their value and operating on their blockchain with its protocol. It is created using complex cryptography and purely used for making payments faster and securely from one end to another. Example: BitCoin, Ethereum, EOS, etc.

The “token” represents digital assets built ON TOP of a blockchain, issued on particular projects which are fungible and used for payments as the coins are used. But, there is a difference, Tokens does not operate on their blockchain rather they are introduced on another platform. For eg. ERC-20 tokens built on the Ethereum platform. To understand this in simple terms, consider the following real-life example; you have a ticket to a movie, which allows you to watch a movie at a particular time but the same ticket won't allow you to board the train and travel. Similarly, a token is used as a payment source but they carry a value only at a particular time based on the issued project, for Example DAO, BON, Augur, CEL, etc.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are directed The DeFi Index, which is a digital asset index designed to track coins'/tokens' performance within the Decentralized Finance industry, on basis of existing blockchains networks functions and transactions assumed as known and this invention is on top of decentralized finance networks functions already available through blockchains' native characteristics or derived as service from the service provider. The index is weighted based on the value of each token's circulating supply, weightage liquidity, and Index divisor to Introduce and expand adoption of blockchain-based projects translated to index products, accessible to a broad audience beyond those already in DeFi today, a system and associated methods for exchange of information, value, or tokens within and between blockchain networks and the real physical world.

Implementations include Index Management and User Managing Index as a digital asset—executes and leverages financial complex algorithms with mainly—Index Token Structure creates and periodic or market triggered reconstitution, User assets distribution and allocations leveraging Index Token structure, Trigger rebalance assets as Index Token Structure change, capital transfer, token Conversion, Wallet Summary, and distribution/allocation, Unrealized gain and loss reporting, disposition, Equalization, Minting/staking/lending based diversification/investments, Token Distribution and Allocation Methods, Reward Distribution.

A system of one or more computers can be configured to perform particular operations or actions by having software, firmware, hardware, or a combination of them installed on the system that in operation causes or cause the system to perform the actions. One or more computer programs can be configured to perform particular operations or actions under including instructions that, when executed by the data processing apparatus, cause the apparatus to perform the actions. One general aspect includes a blockchain-enabled service-based cloud-native function (CNF) architecture. The blockchain-enabled service-based cloud-native function also includes an application service mesh network that may include a plurality of applications configured to communicate with each other. The function also includes where a plurality of smart contracts may include network slicing information from the application service mesh network are recorded to a blockchain network. The function also includes where the network slicing information may include by the plurality of smart contracts is related to one or more of a standard protocol network exposure function (NEF), a standard protocol service communication proxy (SCP), and a standard protocol network repository function (NRF). Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a schematic diagram of a Service-Based Architecture/System design to an embodiment of the invention, that uses and is integrated with externally managed public smart contracts and blockchain.

FIG. 2 is an INDEX TOKEN—The distributed decentralized Index is a capitalization-weighted index that tracks the performance of decentralized financial assets across multiple blockchains.

FIG. 3 is an illustration of an end-to-end process and system flows for Users buying index tokens using fiat money and getting the distribution/allocations to multiple-valued coins/tokens based on index composition. And a process of Index Token management using autonomous processing using index update algorithms triggers rebalancing of users' sub-tokens allocation using a distribution process.

FIG. 4 is an illustration of the smart contracts related to the INDEX TOKEN and the composition using global variable—distribution ratio, and market data used to reconstitute the Index Token contract using composition algorithm

FIG. 5 is an illustration of the smart contracts updates as an update to the INDEX TOKEN and the composition and distribution/allocation to users' wallets, custodian holding, and market data exchanges to the reconstitution of the Index Token contract periodically using Index token composition algorithm.

### DETAILED DESCRIPTION OF THE INVENTION

The present invention will now be described more fully on basis of existing blockchains networks functions and transactions assumed as known and this invention is on top of decentralized finance networks functions already available through blockchains' native characteristics or derived as service from service provider hereinafter regarding the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader about the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred-to object, characteristic, or quality constitutes a majority of the subject of the reference. The meaning of any of these terms is dependent upon the context within which it is used, and the meaning may be expressly modified.

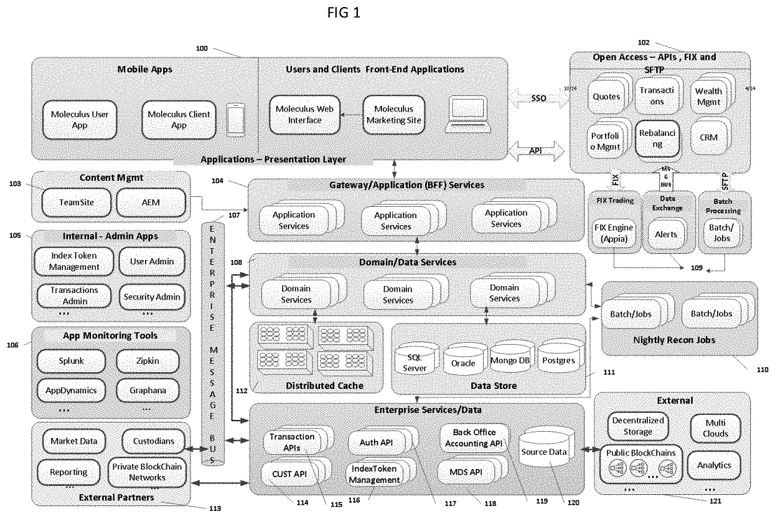

Referring now to FIG. 1 is a schematic diagram of a Service-Based Architecture/high-level system design to an embodiment of the invention, that uses and is integrated with externally managed public smart contracts and blockchain is described in more detail. A user 100 and a service provider 102 may complete a transaction through the use of an application and presentation layer 100 and 102. The application and presentation layer 100 may comprise a web interface and/or a mobile application. Elements of the application and presentation layer 100 and 102 may be the client-facing element of a platform/application services layer 108. The platform/application services layer 108 may comprise security features 104, such as a user identity and access management system 117. The platform/application services layer 108 may further comprise integration services 115, such as, for example, a transaction service 118 or a connector service for applications, cloud services, and token exchanges 113/121. The platform/application services layer 110 may further comprise configuration management features 122. The Token Management features 116 may include an external service provider 113/121, a token distribution management system 119, and users ‘/users’ portfolio management 114/119/120. The platform/application services layer 108 may further comprise accounting and transaction services 115, such as a change management framework 132, a token framework 116, a disbursement framework 110/118, a lending framework 138, and an Index Token wallet 140. The platform/application services layer 108 may further comprise data management and analytics services 121, such as analytics and reporting systems 121, and an advertisement and promotions system 103. The platform/application services layer 108 may function on an infrastructure layer 121 that may comprise one or more of blockchain networks 121/113, decentralized storage platforms 121, decentralized messaging platforms 113, or cloud infrastructures, such as cloud computational resources, cloud storage resources, or cloud networking resources.

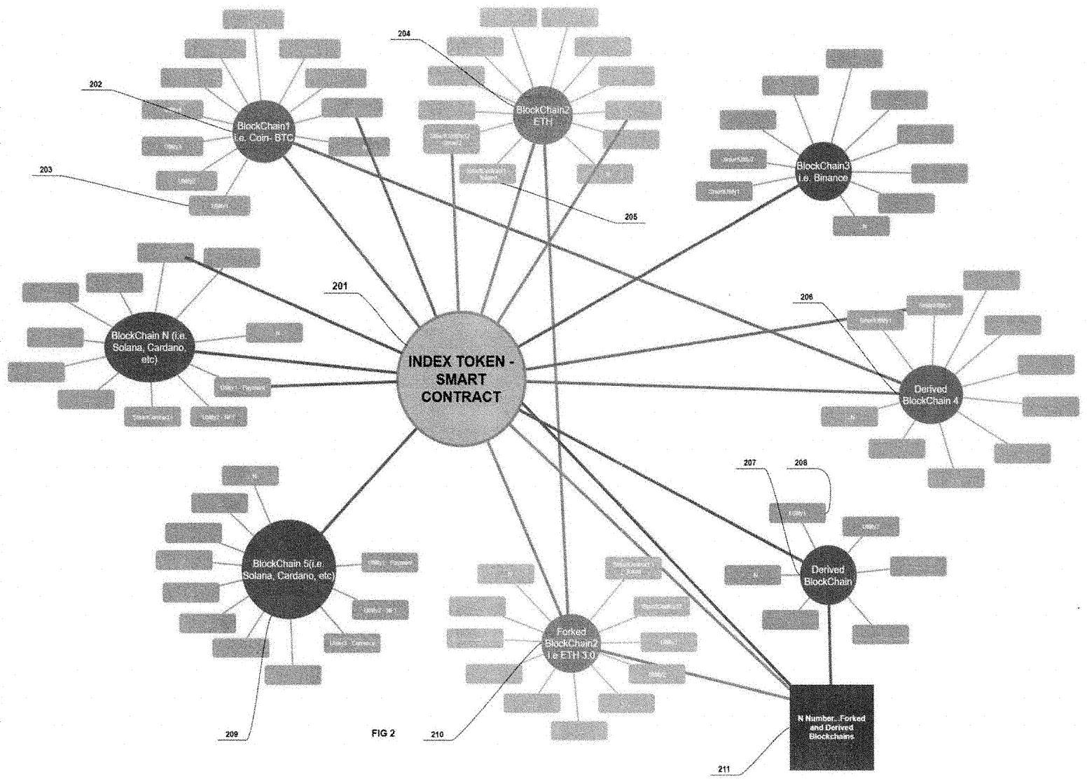

Referring now to FIG. 2 is an INDEX TOKEN (One or multiple index token created, and token name can be any name i.e., IND, MOL, or MOLECULE, etc.)—The distributed decentralized Index is a capitalization-weighted index that tracks the performance of decentralized financial assets across the multiple blockchains, is described in more detail. INDEX TOKEN (Token name can be any name i.e. MOL or MOLECULE) 200 is a digital token/smart contract created on Ethereum blockchain and composition of multiple blockchains 202/204/206 . . . N, consists of sub-set of coins 203/208 and tokens 205/209—high valued projects from multiple blockchains and forked and derived blockchains 211.

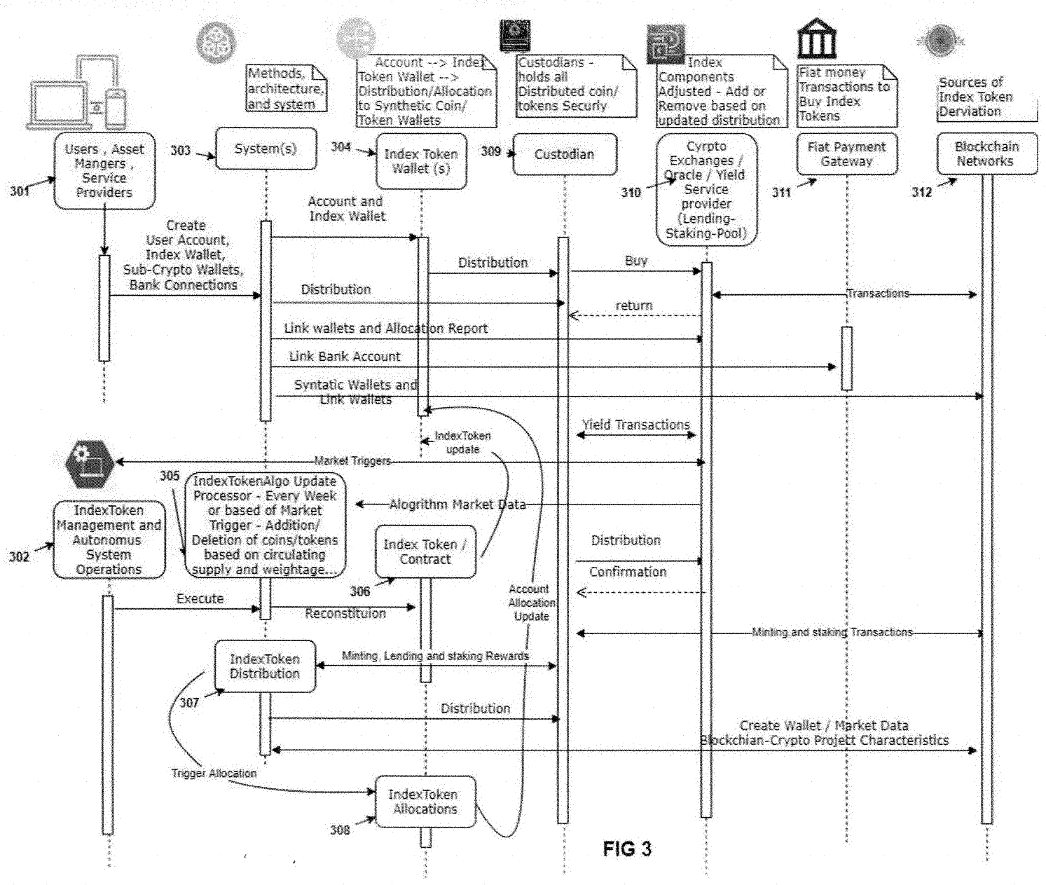

Referring now to FIG. 3 is an illustration of an end-to-end process and system flows for Users buying index tokens using fiat money and getting the distribution/allocations to multiple-valued coins/tokens based on index composition. And a process of Index Token management using autonomous processing using index update algorithms, trigger rebalancing of users' sub-tokens allocation using distribution process, is described in more detail. Users 301 create a user account in system 303 and assign Index token wallet 304, so users can transfer fiat money 311 using linked bank account to index token account and buy index token 304. As user buy index token 306, it's distributed using INDEX TOKEN composition from the current Index Token contract distribution ratio 306 at the time of buying index token, internally system 303 distribute/allocate 307 Index token to sub coins and tokens using crypto exchanges 310, and held at custodian 309. User opens the Index Token App and can see how Index token is distributed to multiple coins and tokens, can track Index token performance based on underlying coins and token valuation changes using market data from crypto exchanges 310. User 301 then can buy more or sell Index tokens and respective underlying coins and tokens will be adjusted as adding new or removed based on current INDEX Token composition. Index Token Autonomous system 302 manages Index composition based on Index Token algorithm 305 which uses multiple parameters and market data from exchanges/blockchain networks 310/312. Index composition updates 302 triggered periodically i.e. Weekly or biweekly or monthly, or based on market triggers. Any update to Index token—triggers reconstitution of Index token/smart contract 306 and triggers distribution and rebalancing/allocation on all underlying coins and tokens at custodian 309 using crypto exchanges 310, users can see alerts and see changes in real-time using apps 301. INDEX TOKEN's underlying coins and tokens leveraged to get additional yields using available secured asset growth options such as lending, pooling, staking, minting, etc within decentralized finance networks, yields received distributed to all Index tokens equally and users see additional growth in their index token valuation.

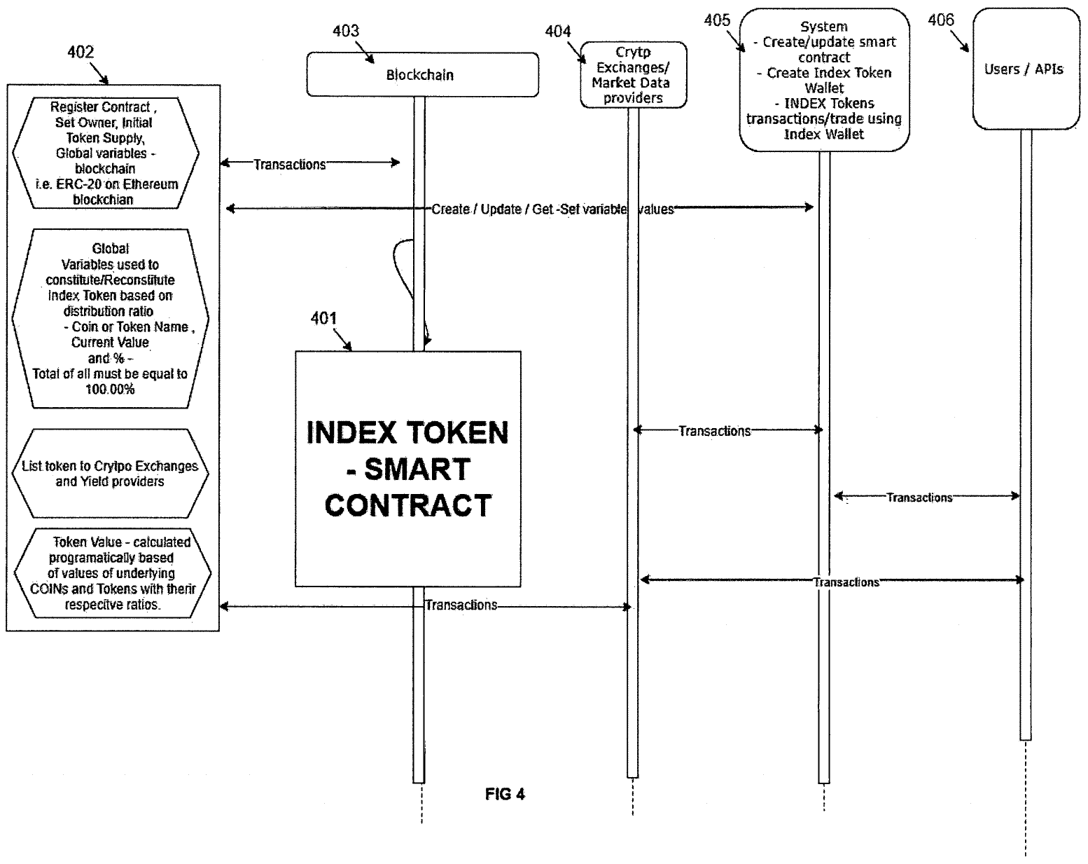

Referring now to FIG. 4 an illustration of a smart contract data source that uses an external publisher client to publish messages to the publish-subscribe messaging framework is described in more detail. A smart contract data source 1800 such as a Solidity smart contract generates notifications or events 1802. A publisher/producer client 1804 watches for the notifications or events generated by the smart contract 1800. When a notification or event is generated, the messages are published 1806 to the topics 1810, 1812 managed by the Bulletin Board 1808. These messages are delivered 1814 to the consumer/subscriber client 1816 which has subscribed to the topics 1810, 1812. The consumer/subscriber client 1816 has a smart contract transaction action configured which sends transactions 1818, 1820 to the linked smart contracts 1822, 1824 on receiving the messages.

Referring now to FIG. 4 is an illustration of the smart contracts related to the INDEX TOKEN and the composition using global variable—distribution ratio, and market data exchanges to the reconstitution of the Index Token contract using composition algorithm is described in more detail. A smart contract 401 data source with integrated publisher/producer client system 402/405 generates transactions or events to create/update/get-set global variables of contract 405. The contact update using global variable updates using the owner of the contract is published as an update to contract 401, managed by system 405. The smart contract was initially created on Ethereum blockchain 403 using ERC-20 token and listed crypto exchanges for buy/sale trading transactions 402/404, a similar method of creating distributed smart contract can be used in any blockchain, not limited to Ethereum and made INDEX Token made available to the public for holding as digital assets via crypto exchanges 404, part of listing to exchange. Index token composition consists of up to 500 coins ‘/tokens’ total, only consist of decentralized finance protocol—distribution ratio and Index token value is derived from underlying Coins' and Tokens' circulation supply, value, volume, volatility, and Index divisor, using programmatic algorithm calculations.

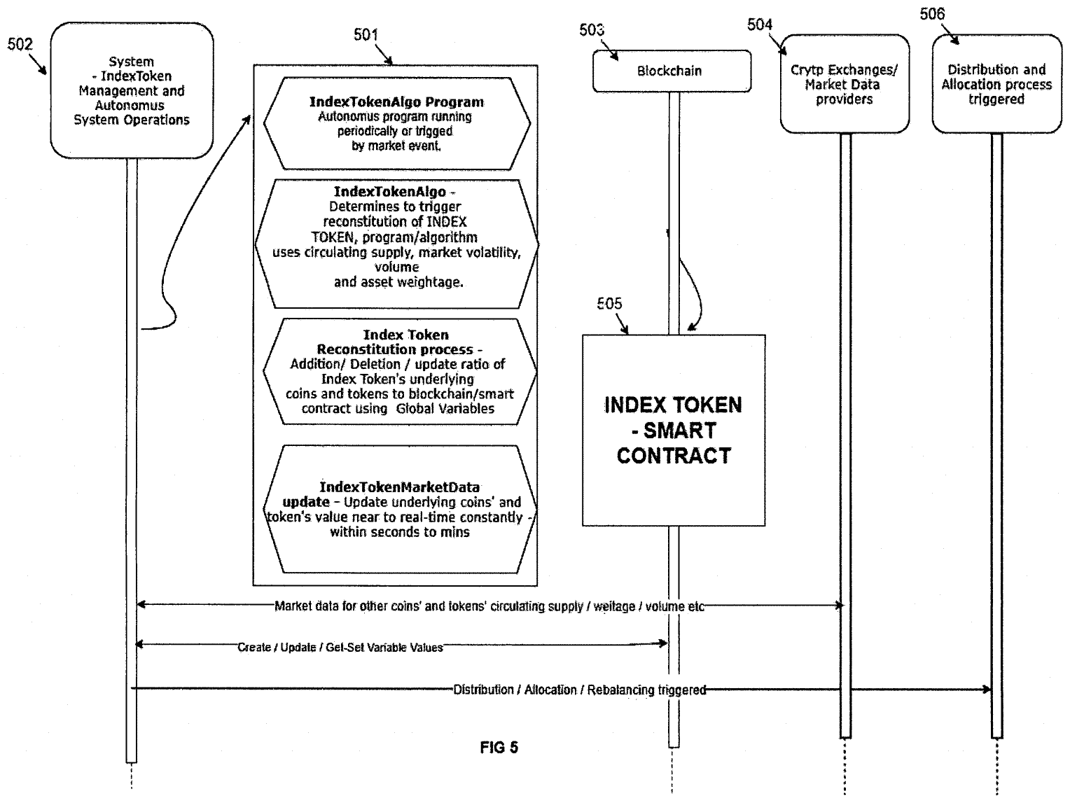

Referring now to FIG. 5 is an illustration of the smart contracts near real-time updates as update to the INDEX TOKEN, the composition and distribution/allocation to users' wallets, custodian holding, and market data exchanges, as reconstitution of the Index Token contract periodically i.e. Weekly, bi-weekly, monthly, etc. using Index token composition algorithm, is described in more detail. An autonomous systemic program/process 501/502 to reconstitute token smart contract IndexToken algorithm 501, which determines INDEX TOKEN distribution ratio and Index Token value—derived from underlying Coins' and Tokens' circulation supply, value, volume, volatility, market strategy signals, triggers, and Index divisor, using programmatic algorithm calculations 501, Initial algorithm claimed here will use below formula and top 10 tokens and coins, but not limited to as multiple variations can be derived using underlying digital coin's and tokens' market data, available using public crypto exchange i.e. Coinbase or market data provider such as CoinGecko as a reference source 504.

$${indexValue}_{[ Total of 100 \% \\ composition of mutiple \\ {tokens}^{′} and {coins}^{′} ]} = {\sum }_{T}^{tokens} \frac{\begin{matrix}\text{?} \\ Supply t\end{matrix} \times \begin{matrix}Valuation / \\ Total Cap t\end{matrix} \times \begin{matrix}Total \# days in \\ Exchanges / Open \\ Market t \\ \begin{matrix}[ Min \# days \\ Market > 180 days ]\end{matrix}\end{matrix} \times \begin{matrix}Avg Daily \\ Trading Cap \\ Volume - \\ Last 30 days t\end{matrix} \times \begin{matrix}Avg Daily \\ Volatility \\ Index for \\ last 30 days t\end{matrix} \times \begin{matrix}\begin{matrix}\begin{matrix}\begin{matrix}\begin{matrix}Total Supply \text{?} \\ circ Supply \text{?}\end{matrix} \\ When its unlimited\end{matrix} \\ supply use t\end{matrix} \\ for total\end{matrix} \\ supply ) t\end{matrix}}{indexDivisor}$$

$$\text{?} \text{indicates text missing or illegible when filed}$$

All of the above-described methods are performable on computerized systems, such systems comprising a processor, a data store (such as memory) positioned in communication with the processor, and a network communication device position in communication with the processor and operable to communicate across a network, as are all known in the art.

Some of the illustrative aspects of the present invention may be advantageous in solving the problems herein described and other problems not discussed which are discoverable by a skilled artisan.

While the above description contains many specificities, these should not be construed as limitations on the scope of any embodiment, but as exemplifications of the presented embodiments thereof. Many other ramifications and variations are possible within the teachings of the various embodiments. While the invention has been described regarding exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. does not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

1. A blockchains-based INDEX token/smart contract derived from multiple coins' and/or tokens' performance within decentralized finance networks and application service architecture comprising: an index token—smart contract comprising a plurality of coins and tokens composition as digital asset index.

2. A blockchains-based INDEX token's constitution and reconstitution autonomous network system comprising: a plurality of tokens and coins derived from underlying Coins' and Tokens' circulation supply, value, volume, volatility, market strategy signals, triggers and Index divisor, using algorithm program calculations as Method and Service application, the application service Index token distribution and allocations on blockchain networks comprising a plurality of applications configured to communicate with each other and a network service of the plurality of processes to distributions to users wallets and update custodians records; wherein a plurality of crypto exchanges, custodian networks and blockchains used to get circulation supply, value, volume, volatility, market strategy signals, triggers and Index divisor comprising application process to manage Index Token and the application service to manage digital assets, recorded to a blockchains and custodians' network linked to Index Token wallets.

3. The architecture of claim 2 wherein: the Index token's composition comprises a plurality of coins and tokens, each coin or token comprising a registered global variable; and the coins and tokens of the plurality are published to Index smart contract periodical schedule by the plurality of applications, such that information regarding updates to the registered global variable comprised by the application and blockchain protocol service call or system messages using automated system program continuously running periodical schedule by every few seconds to mins.

4. A computer-implemented system, comprising: Users creating account and wallet a private computer network over which digital assets can be securely managed to invest in distributed INDEX TOKEN which is tangible digital asset distributed and valued based on underlying coins' and tokens' valuation, which can be bought and sold, and transferred using linked fiat money bank account, perform one or more system processes and operations comprising: Index token's distribution to users' wallets linked to a blockchain network node of a blockchain network directly or using custodian managed wallets.

5. The architecture of claim 1-4 wherein: the first plurality of smart INDEX contract management comprising the first set of Leverage Index token's constitution and distribution recorded to blockchain networks; and the second plurality of smart contract comprising a second Index token's constitution and distribution recorded is recorded to blockchain networks.

6. A blockchains-based INDEX token/smart contract management and application systems' architecture comprising: each Index token/smart contract as a digital asset index fund, using various index distribution strategies/algorithm leveraging digit tokens' market data—circulation supply, value, volume, volatility, market strategy signals, triggers, and Index divisor, Index reconstitution comprising rebalance Index token fund structure periodically leveraging methods and systems process—capital transfer, token transfers, distributed wallets, and distribution/allocation, unrealized gain and loss reporting, disposition, equalization, minting/staking/lending based diversification/investments, token distribution and allocation methods to manage Index Token as digital asset Index Fund.
